(19) United States
(12) Patent Application Publication
(10) Pub. No.: US 2017/0320174 A1
(43) Pub. Date: Nov. 9, 2017

(54) METHOD FOR PRODUCING A TURBINE ENGINE PART

(71) Applicant: Safran Aircraft Engines, Paris (FR)

(72) Inventor: Jean-Baptiste Mottin, Moissy Cramayel (FR)

(73) Assignee: Safran Aircraft Engines, Paris (FR)

(21) Appl. No.: 15/526,485

(22) PCT Filed: Nov. 16, 2015
(86) PCT No.: PCT/FR2015/053091

§ 371 Date: May 12, 2017

(30) Foreign Application Priority Data
Nov. 14, 2014 (FR) 1461035

(51) Int. Cl. B23P 6/00; B23K 35/02; B23K 20/02; B23K 35/30; F01D 5/00; B23K 101/00

(52) U.S. Cl. CPC B23P 6/007; B23K 35/3046; B23K 35/0222; F01D 5/005; B23K 20/026; B23K 35/3033; B23K 2201/001; F05D 2230/237

(57) ABSTRACT

The production method comprises the steps for producing a preform by selective melting, the preform comprising an assembly surface to be brazed to the part to be repaired and containing a brazing material, and then assembling the preform to the turbine engine part by diffusion brazing. The thermal amplitude of the main transformation peak (A1) of the brazing material used to make the preform must at least be twice that of each of the respective thermal amplitudes of the secondary transformation peaks (A2, A3) of this brazing material.

The present invention relates to a method for repairing a turbine engine part, which does not exclude manufacturing it.

Some turbine engine parts, such as, in particular, turbine blades, are subject to erosion or wear causing major damage which must be repaired after a certain number of cycles.

The damage may in particular be in the form of a lack of material. The repair then consists in restoring the original (or very close) shapes and dimensions of the worn part.

To achieve this, several techniques are used in the prior art, including producing a preform by sintering a superalloy powder and a brazing powder (whose melting point is lower than that of the superalloy powder), then bonding the preform onto the part to be repaired by diffusion brazing (hereinafter the term “metal” shall include alloys).

It should be recalled that brazing is a process which consists in assembling, for example, two metal parts of identical or different materials by means of a filler metal, whose melting point is considerably lower than the melting points of the materials of the parts. The solder contained in the filler metal is supplied in the liquid state and the parts are heated by the filler metal, but remain solid.

Diffusion brazing (or transient liquid phase bonding) is an assembly operation of two metal parts similar to brazing, but in which the difference in composition between the filler metal and the parts to be assembled is progressively resorbed by a diffusion heat treatment. This treatment leads to the formation of a quasi-chemically homogeneous bond and whose characteristics are close to those of the parts to be assembled. Diffusion brazing could thus be considered as conventional brazing to which diffusion treatment has been added.

When assembling two parts, the filler metal used has a chemical composition that is close to that of the parts to be assembled, but its melting temperature is lower due to the solder. During diffusion brazing, the solder melts and wets the surfaces to be assembled and then solidifies isothermally by diffusion of the alloying elements in the filler metal into the material of the parts, the composition of which changes and homogenizes with that of the brazing seam thus formed. At the final stage of the diffusion brazing process, the filler metal forms part of the material of the parts and is indistinguishable from it.

Such a method allows for several parts to be assembled, as indicated above, while providing the assembled parts and their bonds with mechanical and metallurgical characteristics comparable to those of the original parts. Moreover, the temperatures used in such a method are compatible with the superalloys commonly used to produce these parts, in particular in the aeronautical field.

However, repairing a part using a substantially flat preform limits the applications of this method. Therefore, in the case of turbine blades, in which the area to be repaired can have a three-dimensional profile with an amount of material to be added which may not be constant over the entire area (e.g. variable thickness), for example, FR 2 978 070 proposes the following:
producing a preform, layer by layer, by selectively melting a powder containing a base material identical or similar to that of the part (also referred to as DMLS—Direct Metal Laser Sintering), the preform having (at least) one assembly surface intended to be brazed to the turbine engine part to be repaired and containing for this purpose a brazing material mixed with the base material, said powder containing the mixture, upon heating to fusion generating heat fluxes, having a main transformation peak of the brazing material, with the greatest amplitude of heat flux, and secondary transformation peaks of the brazing material, with a lesser amplitude of heat flux; and
assembling the preform to the turbine engine part by diffusion brazing.

However, such parts where the area to be repaired can therefore have a three-dimensional profile, with an amount of material to be added which may not be constant over the entire area, are not feasible with the expected quality. In direct manufacturing (producing the preform, layer by layer, through selective melting), it has been found that the molten material is liable to crack severely upon cooling, thus altering the production.

A purpose of the invention is to avoid these situations. For this reason, it has been thought of controlling the shrinkage of the material. More specifically, it has been thought of that the solder should only have one main transformation peak during heating (and/or cooling). To be even more specific, it is proposed that the amplitude of the heat flux of the main transformation peak of the brazing material used to produce the preform is at least twice the respective amplitudes (within 20%) of the heat fluxes of the secondary transformation peaks of this brazing material, as shown in the accompanying figures.

Thus, after mixing the brazing and superalloy powders (including in the case of prealloyed powders, i.e. previously mixed), not only will this compound include two main transformation peaks (one for melting the solder and the other for melting the superalloy), but the amplitudes of the secondary transformation peaks for melting the solder will be much smaller than the amplitude of the main peak.

The method according to the invention can thus be applied to the production of various turbine engine parts and in particular to the repair of turbine blades.

The preform can be produced with a controlled roughness: the preform is more easily brazable when it has a certain roughness, since the solder can then more effectively wet the surfaces to be assembled.

The base material is identical or similar to that of the part to be repaired so as to favour the assembly of the preform by diffusion brazing. Two “similar” materials have at least the same base (e.g. nickel, cobalt, titanium, etc.).

An application of the invention relates to the metallurgical production of the powders of shaped parts intended to be assembled by self-brazing to metal parts capable of receiving them and called receptors. Self-brazing is the autogenous brazing of the shaped part onto the receiving metal part, the brazing elements being contained in the shaped part (which will therefore favourably be three-dimensional).

The self-brazing of this shaped part on the metal part may comprise or be followed by a solid-state diffusion heat treatment, thereby constituting what is commonly referred to as a brazing/diffusion operation, a treatment intended to homogenize the composition and structure of the shaped parts and of the self-brazing bond (bonding area).

Particularly within this context, it is recommended that the chemical composition of the aforementioned base material (used to produce the preform by selective melting) corresponds to a Ni, Co, Ti or Fe-based superalloy and that that of the brazing material corresponds to a Ni, and/or Co, and/or Fe-based alloy in which the melting element is Si and/or B (as known per se, a melting element, for example silicon or boron, is an element that substantially lowers the (solidus) melting temperature of the alloy into which it is introduced).

As to the compound to be supplied to the brazing material so that said amplitude of the heat flux of the main transformation peak of the brazing material is therefore equal to at least twice the respective amplitudes of the heat fluxes of the secondary transformation peaks of this brazing material, it is recommended that it be chosen from Cr, Co, Mo, and Fe. The recommended weight percentage of this compound ranges from 7 to 23%.

These choices are particularly suitable for producing turbine parts, and in particular turbine blades.

In this regard, it is even advisable that, in nominal composition and in weight percentages, the brazing material is a Ni-based alloy with between 9 and 19% of Co, Si, B, but also Cr (it being specified that all percentages in the present description are provided in percent by weight).

By using the so-called NiCoSiB 1060 brazing powder based on Ni and Co 20, Si 4.5, B 3, a balanced result will be obtained between low risk of cracking, resistance to hot corrosion, and final qualities of the base material/brazing material pair, in particular with regard to resistance to high temperature creep.

Advantageously, the amount of chromium in the brazing material is 14%. This particular quantity offers a good compromise between limitation of cracking and strength of parts.

In fact, adding too small an amount of chromium, i.e. less than 9%, would not allow for adequately limiting the occurrence of cracks on the part, whereas too great an amount, i.e. more than 19%, would increase the melting temperature of the brazing material and bring it too close to the melting temperature of the base material, which would embrittle the part.

According to another characteristic of the invention, the preform is produced by selectively melting a base material powder and a brazing powder, the melting temperature of which is less than the melting temperature of the base powder. The dimensional tolerances of the preform will thus be greatly reduced and the final assembly optimized.

The preform which already contains a brazing material can be soldered directly to the part to be repaired, depending on the quantity of brazing material.

Preferably, the preform will contain at least 60% of base material, so as to impart adequate mechanical characteristics to the preform.

In a variant of the invention, the preform is produced by selectively melting a powder containing only the base material.

A brazing material may then be deposited on the assembly surface of the preform.

This deposition is, for example, performed by laser spraying or by plasma spraying a brazing powder, or by co-depositing (electrodepositing) in an aqueous medium.

The thickness of such a deposition will, for example, range from 20 to 200 μm.

The invention also relates to a turbine engine part produced by executing the aforementioned method.

The invention will be better understood and other details, characteristics, and advantages of the invention will appear on reading the following description given by way of non-limiting example and with reference to the accompanying drawings, in which:

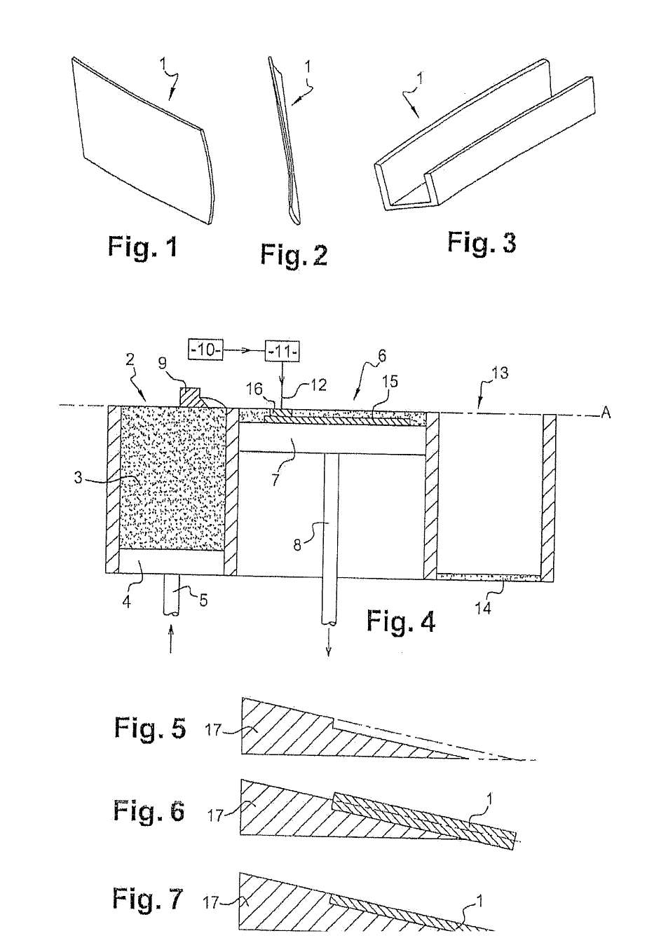

FIGS. 1, 2 and 3 are perspective views of a preform used for repairing a turbine engine blade;

FIG. 4 is a schematic view of a selective melting plant for powder;

FIGS. 5 to 7 are schematic views illustrating different stages of the repair method according to the invention;

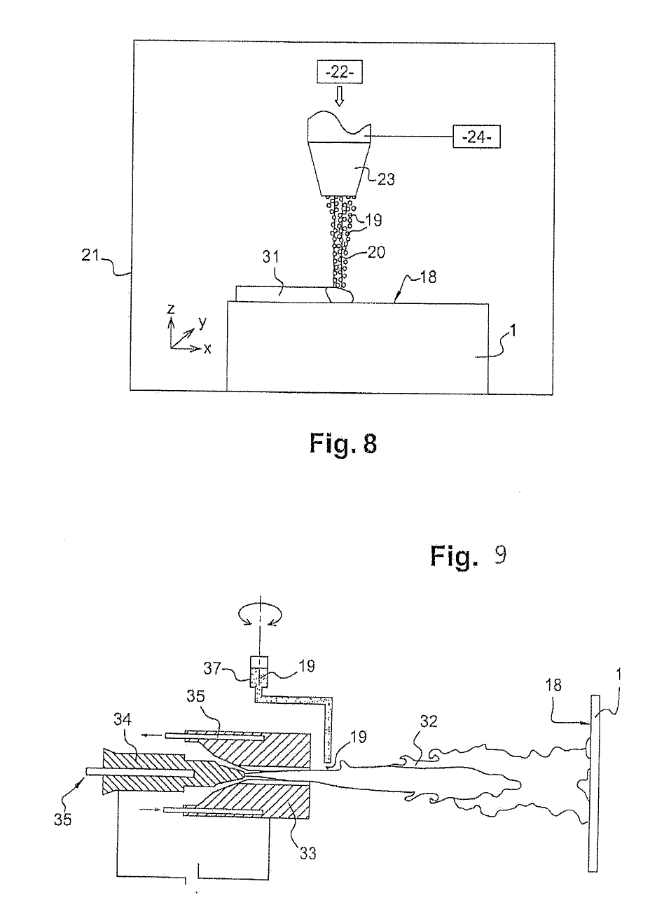

FIG. 8 is a schematic view of a laser spraying system;

FIG. 9 is a schematic view of a plasma spraying system;

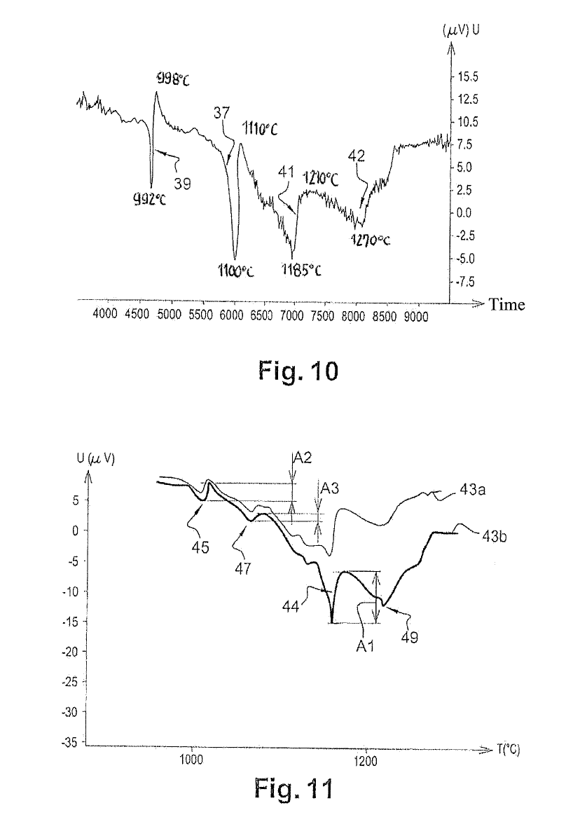

FIG. 10 shows, on a graph, a situation where there is a significant risk of cracking of the molten material in the case where a known composition is used, in accordance with a solution of the prior art;

FIG. 11 shows, on a similar graph, a solution aiming to mitigate this risk, in accordance with what the invention proposes;

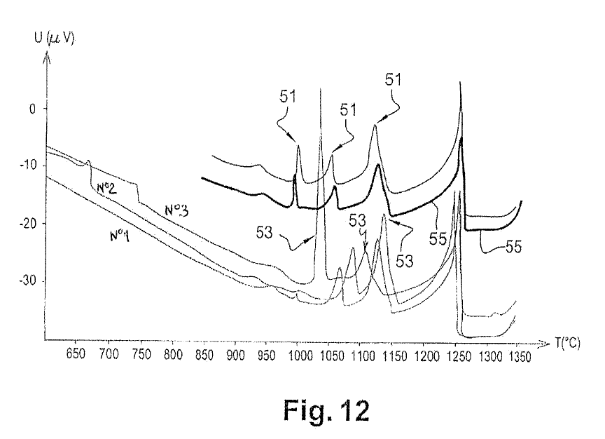

FIG. 12 compares, on a graph similar to those above, but during cooling, the transformation peaks related to the solder without addition of Cr in the present case (bottom curves, nos. 1 to 3), and with addition (top curves);

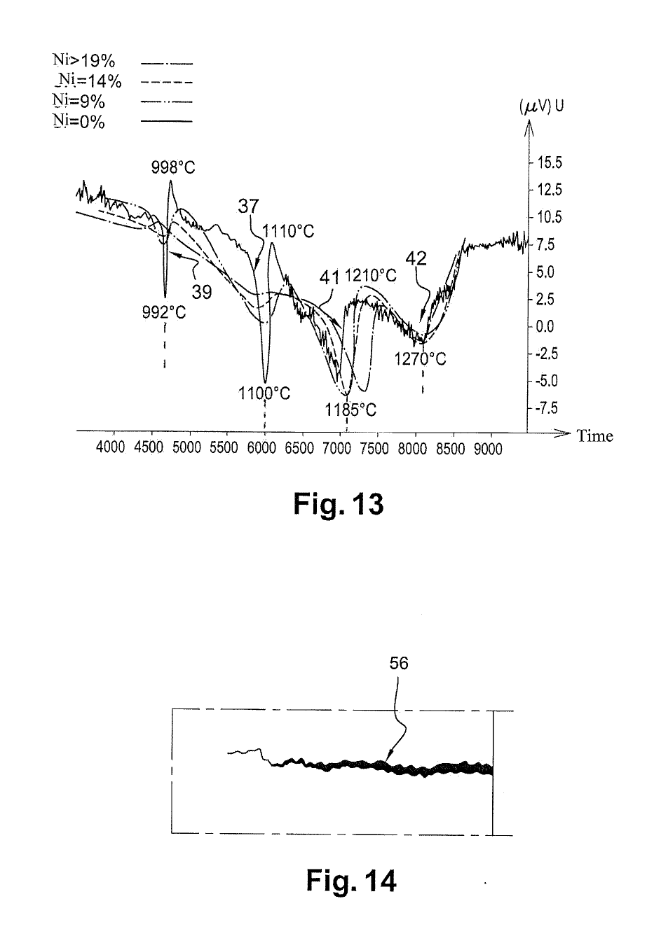

FIG. 13 shows a graph similar to that of FIG. 10 in which three smoothed curves, superimposed on the curve of FIG. 10, schematically represent different configurations of the brazing material comprising a chromium content of 9%, 14% or 19%;

FIG. 14 shows an example of crack when the brazing material does not include chromium;

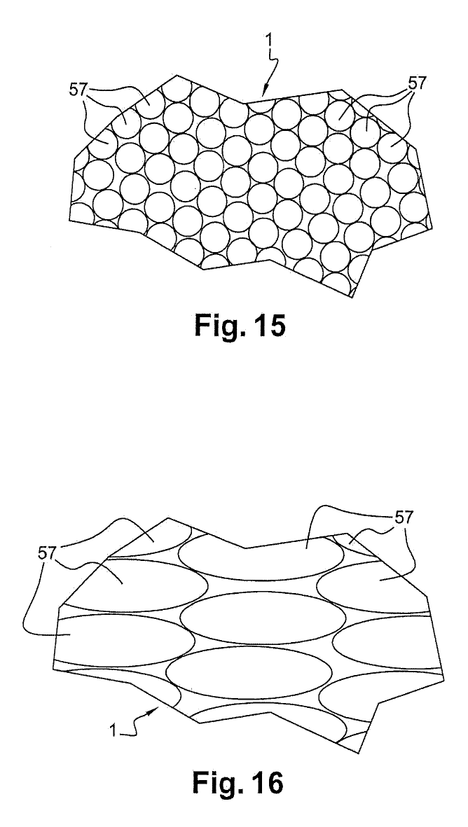

FIG. 15 is a schematic view showing the behaviour of the base material when the brazing material comprises a chromium content of less than 19%; and

FIG. 16 is a schematic view showing the behaviour of the base material when the brazing material comprises a chromium content of more than 19%.

FIGS. 1 and 2 show a preform 1 used in a method for repairing a leading edge or a trailing edge of a turbine blade in a turbine engine, such as an aircraft turbojet or turboprop engine. FIG. 3 shows a preform 1 used in a method for repairing a platform of a blade of this type. In both cases, the preforms 1 have complex three-dimensional shapes.

In a first embodiment, the repair method according to the invention first of all consists in producing, layer by layer, a sintered preform 1 by selectively melting a mixture of powders including a base material powder and a brazing material powder, regardless of whether these materials having been premixed.

The melting temperature of the brazing material is lower than that of the base material. By way of example, the melting temperature of the brazing material will range from 1,000 to 1,300° C., while the melting temperature of the base material will range from 1,200 to 1,600° C.

The base material is preferably a superalloy, e.g. a nickel-based superalloy. In this case, the brazing material also is nickel-based and also comprises melting elements, such as silicon and/or boron.

The selective melting is performed using a plant such as that shown in FIG. 4. This plant comprises a tank 2 containing the mixture of metal powders 3 and the bottom 4 of which is movable and displaceable in translation by an actuator rod 5 and a neighbouring vessel 6 whose bottom consists of a movable plate 7, also displaceable in translation by an actuator rod 8.

The plant further comprises a scraper 9 for supplying powder from the tank 2 to the vessel 6 by moving along a horizontal plane A, and means 10 for generating a laser beam or an electron beam coupled to a computer-controlled device 11 to direct and move the beam 12. Adjacent to the vessel 6, a vat 13 may also be provided to collect excess powder 14.

This plant operates as follows: First, the bottom 4 of the tank 3 is moved upwards so that a certain quantity of powder 3 is situated above the horizontal plane A. The scraper 9 is moved from left to right so as to scrape said layer of powder 3 into the vessel 6 and deposit a thin layer of metal powder onto the horizontal flat surface of the plate 7. The quantity of powder and the position of the plate 7 are determined so as to form a layer of powder of a selected and constant thickness. A laser beam 12 or an electron beam perpendicular to plane A then scans a specific area of the layer formed in the vessel so as to locally melt the brazing powder (and not the base powder). The melted areas then solidify by agglomerating the particles of the base powder and by forming a first layer 15 of a sintered preform 1, this layer 15 having, for example, a thickness of the order of 10 to 150 μm.

More specifically, the thickness of the layer 15 ranges from 10 to 45 μm, respectively from 45 to 150 μm, when the powder is melted by means of a laser beam or respectively by means of an electron beam.

The plate 7 is then lowered and a second layer of powder is supplied, in the same manner as previously, onto the first layer of powder. Through controlled displacement of the beam, a second layer 16 is formed by sintering on the first layer 15.

These steps are repeated until the preform 1 is completely formed. The layers 15, 16 have substantially the same thickness.

In the case where the preform 1 is built layer by layer by selectively melting the powder using a laser beam, the powder has an average particle size ranging from 10 to 45 μm. The particle size distributions of the two powders are not necessarily identical. Preferred are near averages, i.e. the case where the two powders each have an average particle size of between 10 and 45 μm, in order to facilitate mixing of the powders.

In the case where the preform 1 is built layer by layer by selectively melting the powder using an electron beam, the powder has an average particle size ranging from 50 to 100 μm.

This preform 1, which contains an adequate quantity of brazing material, can be brazed directly onto the part to be repaired 17 (FIG. 5).

To achieve this, the surfaces of the preform 1 to be brazed and the part to be repaired 17 are degreased and/or pickled and then the preform 1 is placed on the surface of the part to be repaired (FIG. 6).

The preform 1 is then tacked (laser tacking, condenser discharge, etc.) to the part to be repaired, in order to keep it in place on the part to be repaired 17.

The preform 1 and the part to be repaired 17 are then placed in an oven where they will undergo a diffusion brazing cycle.

For a base material of type NK17CDAT, also known as Astroloy, and for a NiCrB braze material, the diffusion brazing may include a temperature rise to 1,205° C. lasting about 2 hours 30 minutes, a first stage at 1,205° C. lasting 15 minutes, followed by a second stage at 1,160° C. lasting 2 hours, followed by a temperature decrease from 1,160° C. to 20° C. lasting about 1 hour.

During brazing-diffusion, the brazing material melts first. The liquid phase to which it gives rise is retained by capillarity and moistens the surfaces of the part to be repaired 17 and of the preform 1.

After cooling, a solid intermediate layer is formed between the preform 1 and the part to be repaired 17 and has a homogeneous metallographic structure diffusion-bonded to the surfaces of these parts.

The repaired part thus has mechanical characteristics identical or similar to those of a new part.

The repaired part finally undergoes a finishing step in which the repaired surfaces are adjusted or machined in such a way that the part recovers the dimensions of a new part (FIG. 7).

In order to further increase the mechanical characteristics of the preform 1 and hence of the repaired part, said preform 1 may include a reduced or null proportion of brazing material at its core, whereby powder rich in brazing material can then be deposited on the surface to be brazed.

Thus, the preform 1 can be produced by selectively melting a mixture of base powder and brazing powder in which the proportion by weight of the base powder is greater than 90%. The preform 1 may also be produced by selectively melting a base powder only.

In this case, a layer of powder enriched with brazing material must be formed on the surface of the preform. This layer can be produced by laser spraying or by plasma spraying, electrodeposition.

The powder used to form this layer may comprise 60 to 90% by weight of base powder and 10 to 40% by weight of brazing powder.

The principle of laser spray deposition is shown in FIG. 8. This deposition method consists in spraying a powder 19 onto a surface 18 and heating the sprayed powder by means of a laser beam 20 directed toward the surface 18, so that said powder 19 melts and then solidifies on said surface 18.

To achieve this, the preform 1 is placed in an enclosure 21 containing argon, for example. Means 22 for generating a YAG laser beam produce a laser beam 20 directed toward the surface 18 of the preform 1, through a nozzle 23 directed perpendicularly to this surface 18. The nozzle 23 and the laser beam 20 can be moved relative to the surface (or vice versa) by means of a control system and appropriate means 24.

One or several successive layers 31, enriched with brazing material, can thus be formed on the corresponding surface 18 of the preform 1.

The principle of plasma spray deposition is shown in FIG. 9. This deposition method consists in injecting a powder 19 into a plasma jet 32 where it is melted and projected at high speed towards the surface to be coated 18. The plasma jet 32 is produced inside a torch by an electric arc generated between two electrodes 33, 34 cooled by means of a cooling circuit 35. The difference in potential between the two electrodes 33, 34 is established by a generator 36.

The melting of the powder grains 19 is due to the very high temperatures within the plasma, making it possible to deposit materials with a high melting point.

As it solidifies, the material of the powder forms a deposit on the surface 18 of the preform 1.

The high velocities of the gases and particles allow obtaining strong adhesion of the deposit, low porosity, and a reduced level of chemical transformation.

Typical examples of the chemical composition of the base material are provided below. The reference and the corresponding chemical composition (percent by weight) are provided for each material:
Astroloy (NK17CDAT): nickel base, cobalt: 16.9%, chromium: 14.8%, aluminium: 3.87%, titanium: 3.45%, molybdenum: 5.1%, carbon: 0.015%.
SYP3: nickel base, cobalt: 17%, chromium: 15%, molybdenum: 5%, titanium: 3.5%, aluminium: 4%.

Note that Astroloy is the material giving the best results during the tests.

In the same manner, the chemical composition of the brazing material is provided below:
NiCoSiB 1060=TY 134b;
TY 134b: nickel base, cobalt: 18 to 22%, silicon: 4 to 5%, boron: 2.7 to 3.15%, carbon: 0 to 0.06%.

By way of example, the mixture of powders (base material/brazing material) may comprise 75% by weight of SYP3 or Astroloy powder (base material) and 25% by weight of TY 134b powder (brazing material). Alternatively, this mixture may comprise 70% by weight of base material powder and 30% by weight of brazing material.

FIGS. 10 to 16 correspond to a situation in which the base material is Astroloy and the brazing material is TY134b, as defined above.

FIG. 10 shows that with a composition of the type in which Astroloy and TY134b are mixed there still is considerable risk that the molten material will crack.

In fact, on the illustrated Differential Thermal Analysis graph of the above mixture of powders, showing the development of the part's heat flux, i.e. the voltage U as a function of time, where the mixture reaches more than 1,300° C. after more than 1 hour of heating, the following can be distinguished:
A main peak 37 in the transformation of the brazing material, of a greater thermal amplitude,
And, on either side, two secondary peaks 39, 41 in the transformation of this same brazing material, of smaller thermal amplitudes than the main peak, as can be seen.

Later, in a comparable temperature range (between 900° C. and 1,140° C.), the occurrence of the peak(s) (referred to as a whole 42) of transformation of the base material, in this case a superalloy.

The precise temperature and time values at which they occur can be read in FIG. 10, where the temperatures in ° C. are noted directly on the graph. The amplitude of the peaks (A1/A2/A3 FIG. 11) is related to the heat flows. The time displayed on the abscissa is not of major interest in our case. For FIGS. 11 and 12, the heat flux is plotted on the ordinate and the temperature is plotted on the abscissa.

Measurement of the heat flux of the material concerned can be achieved using an “RDF Micro-Foil”® sensor. This sensor is connected to a microvoltmeter (voltage U). The whole then provides a direct measurement of the rate of transfer of heating or cooling through both the sensor and the mounting surface. There is a direct relationship between the output of the microvoltmeter and the heat flow. In FIGS. 11-12, negative voltage values indicate that this is an exothermic reaction, the values carried over being obtained by comparison with a standard measurement performed using an empty crucible.

In a graph of this nature, the two examples with curves 43a and 43b in FIG. 11 thus each show a solution in accordance with the invention aiming to enable the de facto production of a part through direct manufacturing, according to one of the techniques introduced above, but with a solder on a base known as “RBD 61” (i.e. an Astroloy+TY 134b mixture), but with Cr added (in this case between 9 and 19%, e.g. at 14%) for example having the following for curve 43b:
Not only a single main peak 44 in the transformation of the brazing material used to produce the preform during heating (this being identical during cooling)
But also a thermal (i.e. heat flux) amplitude A1 of this main peak 44 which is at least twice of each of the thermal amplitudes, respectively A2 and A3, of the secondary peaks 45, 47 in the transformation of this same brazing material.

Again, at higher temperatures (for temperatures above 1,200° C.), one finds the transformation peak(s) (referred to as a whole 49) of the base superalloy.

FIG. 12 further shows that during cooling the transformation peaks 51 related to the “doped” braze (and thus the chromium added in the selected preferred example) are attenuated with respect to what they would have been (see reference numerals 53 for curve No. 3, for example) without adding chromium to the alloy under consideration.

FIG. 13 shows the behaviour of the material of FIG. 10 with different chromium contents in the brazing material. The curve in solid lines shows the behaviour of a brazing material devoid of chromium. The result, after heating of such a brazing material, is illustrated in FIG. 14 which shows a crack 56 that has appeared after the part obtained has cooled.

The three dashed curves (refer to the legend of the figure to identify each one) show the behaviour of the mixture of the base material and the brazing material when the brazing material comprises 9%, 14% and 19% chromium respectively.

It is observed that the higher the concentration of chromium the less the thermal amplitudes of the transformation peaks are pronounced for temperatures below 1,185° C. Thus, the risk that the parts will crack will indeed be limited.

The reference 55 identifies the curve showing the changes in the base material, i.e. the selected superalloy.

For the sake of clarity, we shall define the following:
A “transformation peak” of the brazing material (in fact, this also applies to the base material, in this case a superalloy), such as the melting start temperature (or temperature range) of the brazing material (respectively, of the base material); and
The “amplitude of a heat flux” (or thermal amplitude) (Ai), as the difference between two heat flux values, for the same sample, at two temperature values that are very close one to another, less than 50° C.

Thus, after mixing the solder and superalloy powders, this compound comprises two transformation peaks (one for the melting of the solder and the other for the melting of the superalloy). The decrease in the number of transformation peaks during heating as well as during cooling makes it possible to limit the stresses that the part is exposed to during cooling and to avoid any cracking.

However, it is also noted in FIG. 13 that the increase in the percentage of chromium has the effect of increasing the melting temperature of the brazing material. Thus, for the curve corresponding to the use of a brazing material having a concentration of 19% chromium, the difference in melting temperature, relative to the melting temperature of a brazing material devoid of chromium, is of about 25° C. (1,210° C.-1,185° C.), which is a significant increase, from 1,200° C. It should also be noted that the curves corresponding to the use of a brazing material having a concentration of 9% or 14% of chromium have a melting temperature close to that of a brazing material lacking chromium respectively ranging from 1,185° C. to 1,195° C. and 1,195° C. to 1,205° C.

The addition of chromium to the brazing material increases the melting temperature of the brazing material, which comes closer to the melting temperature of the material that the part to be repaired is made of.

Preferably, the brazing material is determined so that its melting temperature is at most 1,210° C. and preferably less than 1,210° C.

While it would allow limiting the occurrence of cracks during cooling, any amount of chromium above 19% would generate a problem in the behaviour of the material the part is made of. In fact, the melting temperature of the brazing material will then be close to that of the material the part is made of so that, when the part is heated, the material of which the part is made will react to the heat required to melt the brazing material.

FIG. 15 schematically shows the behaviour of the material of which the part to be repaired is made when the brazing material includes an amount of chromium ranging from 9% to 19%. It can be observed that the particles 57 of the material that the part 1 to be repaired is made of are distributed in a quasi-homogeneous manner, which allows for good mechanical strength to be imparted to the part.

The behaviour of the material that the part to be repaired is made of will be as shown schematically in FIG. 16 when the amount of chromium that the brazing material comprises is greater than 19%. An increase in size of the particles 57 of the material that the part 1 to be repaired is made of can be observed. This size increase then generates a brittleness of the part 1 and a resistance to mechanical stresses that is clearly lower than that of the part 1 in FIG. 15.

By way of example based on a favourable embodiment, a given part may in particular be manufactured from a nickel-based superalloy using the powder metallurgy method thus using a base powder A and a brazing powder B. The base powder A may be that known under the trade name Astroloy (NK17CDAT according to the AFNOR designation). This material is fully compatible with the superalloy called René77 used to manufacture a blade, specifically in as far as solidus temperature and mechanical characteristics are concerned.

The solidus temperature of the base powder A is 1,240° C. Its liquidus temperature is 1,280° C. The brazing powder B used to perform the sintering of the Astroloy powder and the self-brazing with the blade is a 1060 Ni—Co—Si—B alloy powder containing 17% Co, 4% Si, and 2.7% B by weight. The solidus temperature of the brazing powder B is 965° C. Its liquidus temperature is 1,065° C. and is lower than the solidus temperatures of the base powder A and that of the blade. These data can be used to define a self-brazing temperature of 1,200° C., which is higher than the liquidus temperature of the brazing powder, but which is lower than the solidus temperature of the blade made of Rene 77 and that of the Astroloy powder A.

Thus, the self-brazing temperature will be higher than the liquidus temperature of the brazing powder and lower than the solidus temperatures of the base powder and of the receiving part (such as the aforementioned part 17), while the sintering of the blank (such as the aforementioned preform 1) will have taken place at a temperature higher than the liquidus temperature of the brazing powder but lower than the temperature of the subsequent self-brazing treatment. It will thus be possible to obtain a part of a shape that is suitable for self-brazing, the relative density of which is at least equal to 95%.

As taught in FR 2785559, it is advisable that, in practice, in the application intended for aeronautical turbine engines and in particular for turbine elements, more specifically vanes and/or distributors for low-pressure turbines, the following is observed, regardless of whether in combination or not, in order to optimize the quality of the production, accounting for the known general state of the art:
The brazing material must be an alloy containing 4 to 5% Si by weight;
The brazing material must be an alloy containing 2.7 to 3.15% B by weight;
The weight percentage of the brazing material in the powder containing the brazing material mixed with the base material must be between 5 and 40%;
The preform (1) contains at least 60% base material.

The method according to the invention makes it possible to repair various turbine engine parts. In fact, since the preform is built layer by layer by selectively melting powder, the preform may have a three-dimensional shape and, if necessary, a variable thickness.

1. A method for repairing a turbine engine part, characterized in that it comprises the steps of:
producing a preform, layer by layer, by selectively melting a powder containing a base material identical or similar to that of the part, the preform having an assembly surface intended to be brazed to the part to be repaired and containing for this purpose a brazing material mixed with the base material, the brazing material being an alloy based on nickel, cobalt: 18 to 22%, silicon: 4 to 5%, boron: 2.7 to 3.15%, and carbon: 0 to 0.06%, all in percent by weight, said powder containing the mixture, upon heating to fusion generating heat fluxes, having a main transformation peak of the brazing material, with the greatest amplitude of heat flux, and secondary transformation peaks of the brazing material, with a lesser amplitude of heat flux;
assembling the preform to the turbine engine part by diffusion brazing,
wherein the amplitude of the heat flux of said main transformation peak of the brazing material used to make the preform is at least twice the amplitudes of the respective heat fluxes of the secondary transformation peaks of the brazing material, the brazing material further comprising chromium so as to limit the cracking of the parts when they are cooled.

2. The method of claim 1, wherein the quantity of chromium added ranges from 9% to 19% in percent by weight.

3. The method of claim 1, wherein the quantity of chromium added is equal to 14% in percent by weight.

4. The repair method of claim 1, wherein the chemical composition of the base material corresponds to a Ni, Co, Ti, or Fe-based superalloy and the chemical composition of the brazing material corresponds to a Ni and/or Co and/or Fe-based alloy, in which the melting element is Si and/or B.

5. The repair method of claim 1, wherein the preform is produced by selectively melting a base material powder and a brazing powder, the melting temperature of which is less than the melting temperature of the base material powder.

6. The method of claim 1, wherein the melting temperature of the brazing material is at most equal to 1,210° C.

7. The method of claim 1, wherein the base material is Astroloy (also known as NK17CDAT) having a chemical composition of nickel base with 16.9% cobalt, 14.8% chromium, 3.87% aluminium, 3.45% titanium, 5.1% molybdenum, and 0.015% carbon, all in percent by weight.

8. A turbine engine part produced by executing the method of claim 1.
